(19) United States
(12) Patent Application Publication
(10) Pub. No.: US 2022/0206332 A1
(43) Pub. Date: Jun. 30, 2022

(54) Double-screen Tablet Computer for Students

(71) Applicant: Fujian Tianquan Education Technology Limited, Fuzhou, Fujian (CN)

(72) Inventors: Dejian Liu, Fuzhou, Fujian (CN); Ming Chen, Fuzhou, Fujian (CN); Guocheng Xu, Fuzhou, Fujian (CN); Ze Zheng, Fuzhou, Fujian (CN); Chen Lin, Fuzhou, Fujian (CN)

(73) Assignee: Fujian Tianquan Education Technology Limited, Fuzhou, Fujian (CN)

(21) Appl. No.: 17/258,435

(22) PCT Filed: Nov. 30, 2020
(86) PCT No.: PCT/CN2020/132668

§ 371 Date: Jan. 6, 2021

(30) Foreign Application Priority Data
Nov. 20, 2020 (CN) 202022714457.2

(51) Int. Cl. G02F 1/1333; G02F 1/167; G02F 1/16753

(52) U.S. Cl. CPC G02F 1/133382; G02F 1/133342; G02F 2201/44; G02F 1/167; G02F 1/16753; G02F 1/133308

(57) ABSTRACT

A double-screen tablet computer for students comprises a tablet computer body, a liquid crystal screen assembly and an ink screen assembly, wherein the liquid crystal screen assembly and the ink screen assembly are disposed on a front side and a back side of the tablet computer body respectively and are electrically connected to the tablet computer body. The back side provided with the ink screen assembly has a heat-dissipation region. The two sides of the tablet computer can fulfill different display functions to adapt to more application scenarios, and the tablet computer has a good heat-dissipation effect.

### TECHNICAL FIELD

The invention relates to the field of tablet computers, in particular to a double-screen tablet computer for students.

### DESCRIPTION OF RELATED ART

At present, most tablet computers used for students are provided with one screen and are designed by inputting teaching contents to common tablet computers to make the tablet computers suitable for teaching scenarios. If the display screen of the existing tablet computers for students is a color screen, it will do harm to the eyes of the students, and a variety of contents displayed by the color screen may make younger students absent-minded during the studying process. If the tablet computers are provided with two screens (a color screen on one side and an ink screen on the other side), heat can only be dissipated via side edges, which leads to poor heat-dissipation of the tablet computers with two screens.

### TECHNICAL FIELD

The technical issue to be settled by the invention is to provide a double-screen tablet computer for students, which has different display functions and overcomes the defect of poor heat-dissipation of existing tablet computers for students.

### TECHNICAL SOLUTION

The technical solution adopted by the invention to settle the aforesaid technical issue is as follows:

A double-screen tablet computer for students comprises a tablet computer body, a liquid crystal screen assembly and an ink screen assembly;

The liquid crystal screen assembly and the ink screen assembly are disposed on a front side and a back side of the tablet computer body respectively and are electrically connected to the tablet computer body;

The back side provided with the ink screen assembly has a heat-dissipation region.

Furthermore, the tablet computer body comprises a holder, a frame and a PCBA;

The holder is disposed in the frame;

The PCBA is disposed on a side, facing the liquid crystal screen assembly, of the holder;

The liquid crystal screen assembly and the ink screen assembly are respectively disposed at openings in two sides of the frame.

Furthermore, the frame is made of aluminum alloy.

Furthermore, the holder is made of plastic.

Furthermore, the holder is connected to the frame in a buckled manner through buckles.

Furthermore, the double-screen tablet computer further comprises a camera;

The camera is disposed on a side, backing onto the liquid crystal screen assembly, of the tablet computer body and is covered with the ink screen assembly;

The camera is electrically connected to the tablet computer body.

Furthermore, the camera is detachably connected to the tablet computer body through buckles.

Furthermore, a mounting groove is formed in a side face of the tablet computer body;

An attraction member for attracting a writing pen is disposed in the mounting groove.

Furthermore, the attraction member is a magnet.

Furthermore, the liquid crystal screen assembly is an LCD screen assembly.

### Beneficial Effects

The invention has the following beneficial effects: the liquid crystal screen assembly and the ink screen assembly are disposed on the front side and the back side of the tablet computer body respectively, so that the two sides of the tablet computer have different display functions. Considering that both the liquid crystal screen assembly and the ink screen assembly will generate heat in operation, the heat-dissipation region is reserved on the back side provided with the ink screen assembly to ensure that the tablet computer has a large heat-dissipation area, the ratio of the area of an ink screen to the area of the tablet computer is decreased, a heating area of the tablet computer is reduced, and the heat-dissipation effect of the tablet computer is guaranteed. Wherein, the liquid crystal screen assembly can be used for video playing, live-video teaching and the like, the ink screen assembly is suitable for in-class tests, examinations, reading or the like, and contents displayed by the ink screen assembly are limited by the function of the ink screen, so that students can pay their attention to the contents on the ink screen assembly when doing exercises or reading. According to the invention, the liquid crystal screen assembly and the ink screen assembly which are respectively disposed on the front side and the back side of the tablet computer body enrich the functions of the tablet computer for students, the ink screen can reduce harm to the eyes of students, and the heat-dissipation effect is good.

### BRIEF DESCRIPTION OF THE SEVERAL VIEWS OF THE DRAWINGS

FIG. 1 is a first exploded view of a double-screen tablet computer for students provided by the invention;

FIG. 2 is an enlarged view of FIG. 1;

FIG. 3 is a second exploded view of the double-screen tablet computer for students provided by the invention;

FIG. 4 is a third exploded view of the double-screen tablet computer for students provided by the invention;

### REFERENCE SIGNS

1, tablet computer body; 11, holder; 12, frame; 121, rabbet; 122, mounting groove; 13, PCBA; 14, attraction member; 15, writing pen; 2, liquid crystal screen assembly; 3, ink screen assembly; 31, heat-dissipation region; 4, camera; 5, battery.

### DETAILED DESCRIPTION OF THE INVENTION

The technical contents, purposes and effects of the invention are expounded below in conjunction with the embodiments and accompanying drawings.

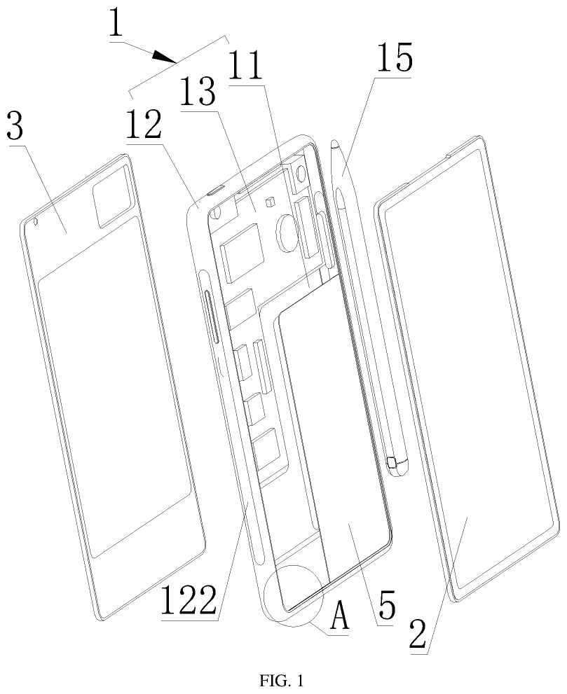

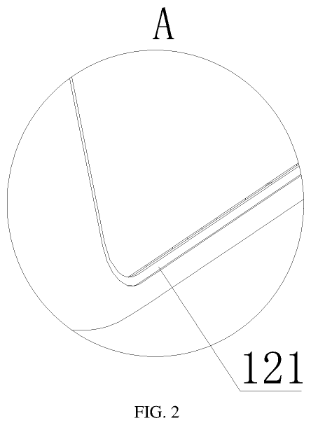

Referring to FIG. 1 to FIG. 4, a double-screen tablet computer for students comprises a tablet computer body, a liquid crystal screen assembly and an ink screen assembly, wherein the liquid crystal screen assembly and the ink screen assembly are disposed on a front side and a back side of the tablet computer body respectively and are electrically connected to the tablet computer body;

The back side provided with the ink screen assembly has a heat-dissipation region.

The operating principle of the invention is as follows:

The tablet computer body is provided with the liquid crystal screen assembly and the ink screen assembly, thus having two display effects and being suitable for more application scenarios;

A heat-dissipation space is reserved on the back side provided with the ink screen assembly, so that the ratio of the area of an ink screen to the area of the tablet computer is decreased, and the heat-dissipation effect of the tablet computer is improved.

From the above description, the invention has the following beneficial effects: the liquid crystal screen assembly and the ink screen assembly are disposed on the front side and the back side of the tablet computer body respectively, so that the two sides of the tablet computer have different display functions. Considering that both the liquid crystal screen assembly and the ink screen assembly will generate heat in operation, the heat-dissipation region is reserved on the back side provided with the ink screen assembly to ensure that the tablet computer has a large heat-dissipation area, the ratio of the area of the ink screen to the area of the tablet computer is decreased, a heating area of the tablet computer is reduced, and the heat-dissipation effect of the tablet computer is guaranteed. Wherein, the liquid crystal screen assembly can be used for video playing, live-video teaching and the like, the ink screen assembly is suitable for in-class tests, examinations, reading or the like, and contents displayed by the ink screen assembly are limited by the function of the ink screen, so that students can pay their attention to the contents on the ink screen assembly when doing exercises or reading. According to the invention, the liquid crystal screen assembly and the ink screen assembly which are respectively disposed on the front side and the back side of the tablet computer body enrich the functions of the tablet computer for students, the ink screen can reduce harm to the eyes of students, and the heat-dissipation effect is good.

Furthermore, the tablet computer body comprises a holder, a frame and a PCBA;

The holder is disposed in the frame;

The PCBA is disposed on a side, facing the liquid crystal screen assembly, of the holder;

The liquid crystal screen assembly and the ink screen assembly are respectively disposed at openings in two sides of the frame.

From the above description, the PCBA is integrated with a chip and modules for realizing different functions of the tablet computer body, so that the modules and the chip are integrated.

Furthermore, the frame is made of aluminum alloy.

Furthermore, the fixing frame is connected to the frame in a buckled manner through buckles.

From the above description, the holder is connected to the frame in the buckled mode through the buckles, so that the holder can be easily assembled on or disassembled from the frame.

Furthermore, the thickness of the double-screen tablet computer for students is 9.5 mm-9.7 mm.

From the above description, the thickness of the double-screen tablet computer for student is set to 9.5 mm-9.7 mm, so that a sufficient battery space is guaranteed to ensure that the battery life of the tablet computer is long enough for one day of studying; an appropriate heat-dissipation space between the two screens is guaranteed to further ensure a good heat-dissipation property of the tablet computer. In addition, the tablet computer with this thickness is more practical, can be handheld by students, especially younger students, is easy to carry and occupies less space.

Furthermore, the double-screen tablet computer for students further comprises a camera;

The camera is disposed on a side, backing onto the liquid crystal screen assembly, of the tablet computer body and is covered with the ink screen assembly;

The camera is electrically connected to the tablet computer body.

From the above description, the camera enriches the functions of the tablet computer body.

Furthermore, the camera is detachably connected to the tablet computer body through buckles.

From the above description, the camera is connected to the tablet computer body through buckles, so that the connecting stability of the camera and the tablet computer body is improved.

Furthermore, a mounting groove is formed in a side face of the tablet computer body;

An attraction member for attracting a writing pen is disposed in the mounting groove.

Furthermore, the size of a display region of the liquid crystal screen assembly is 6.98 inches.

Furthermore, the size of a display region of the ink screen assembly is 5.65 inches.

From the above description, the size of the display region of the liquid crystal screen assembly is 6.98 inches, and the size of the display region of the ink screen assembly is 5.65 inches, so that the size of the display region of the liquid crystal screen assembly and the size of the display region of the ink screen assembly are optimized under the precondition that the tablet computer is made ultrathin, and the display effect is guaranteed. Compared with the sizes of existing tablet computers for teaching, the sizes of the double-screen tablet computer allow the double-screen tablet computer to be handheld and carried by students more easily.

### Embodiment 1

Referring to FIG. 1-FIG. 4, a double-screen tablet computer for students comprises a tablet computer body 1, a liquid crystal screen assembly 2 and an ink screen assembly 3, wherein the liquid crystal screen assembly 2 and the ink screen assembly 3 are disposed on a front side and a back side of the tablet computer body 1 respectively and are electrically connected to the tablet computer body 1, and the back side provided with the ink screen assembly 3 has a heat-dissipation region 31. Preferably, the liquid crystal screen assembly 2 is an LCD screen assembly and has a size of 6.98 inches, and an ink screen is an E-ink screen and has a size of 5.65 inches; and the heat-dissipation region 31 is located on one side or two sides of the ink screen assembly 3. The thickness of the tablet computer is 9.5 mm-9.7 mm, and is preferably 9.7 mm to ensure that there is a sufficient space for mounting a battery 5 and there is a sufficient heat-dissipation space between the two screens.

### Embodiment 2

Referring to FIG. 1, on the basis of Embodiment 1, the tablet computer body 1 of the double-screen tablet computer for students comprises a holder 11, a frame 12 and a PCBA 13, wherein the holder 11 is disposed in the frame 12, the PCBA 13 is disposed on a side, facing the liquid crystal screen assembly 2, of the holder 11 through screws, and the liquid crystal screen assembly 2 and the ink screen assembly 3 are respectively disposed at openings in two sides of the frame 12. Preferably, the frame 12 is made of aluminum alloy, and the holder 11 is made of plastic. Specifically, the battery 5 is disposed on the holder 11 and is electrically connected to the PCBA 13, the liquid crystal screen assembly 2 and the ink screen assembly 3. Wherein, the PCBA is a printed circuit board. Specifically, the holder 11 is connected to the frame 12 in a buckled manner through buckles, rabbets 121 for mounting the liquid crystal screen assembly 2 and the ink screen assembly 3 are formed in peripheries of the openings in the two sides of the frame 12, and tempered glass of the liquid crystal screen assembly 2 and tempered glass of the ink screen assembly 3 are bonded and pressed in the rabbets 121 of the frame 12 through a press.

### Embodiment 3

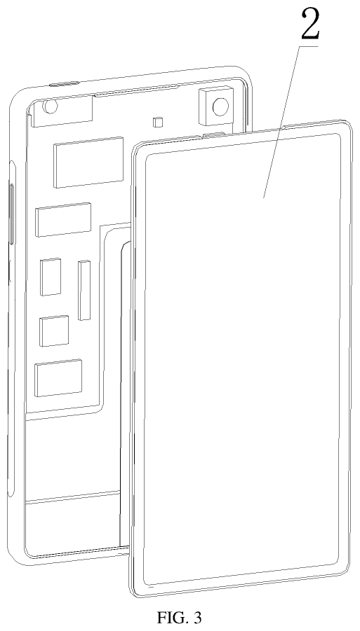

Referring to FIG. 3, on the basis of Embodiment 1 or Embodiment 2, the double-screen tablet computer for students further comprises a camera 4, wherein the camera 4 is disposed on a side backing onto the liquid crystal screen assembly 2, is covered with the ink screen assembly 3 and is electrically connected to the PCBA 13. Specifically, the camera 4 is connected to the PCBA 13 in a buckled manner through buckles, and a tempered glass cover of the ink screen assembly 3 covers the camera 4 to press the camera 4 against the PCBA 13.

### Embodiment 4

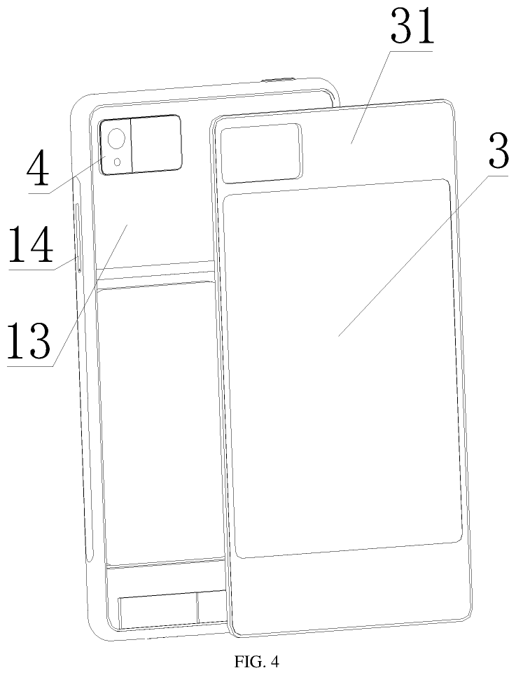

Referring to FIG. 1 and FIG. 4, on the basis of Embodiment 1, Embodiment 2 or Embodiment 3, a mounting groove 122 is formed in a side face of the tablet computer body 1 of the double-screen tablet computer for students, and an attraction member 14 for attracting a writing pen 15 is bonded in the mounting groove 122. Preferably, the attraction member 14 is a magnet for attracting the writing pen 15, so that the writing pen 15 can be stored even if no protective sleeve is disposed around the tablet computer. Specifically, the mounting groove 122 is formed in a side face of the frame 12, and a wireless charging assembly for charging the writing pen 15 is disposed in the frame 12.

To sum up, according to the double-screen tablet computer for students, two sides of the tablet computer have different display functions; an ink screen is low in energy consumption, is more suitable for scenarios such as reading and writing and can prevent students from being attracted by other contents; a liquid crystal screen is more suitable for scenarios requiring color display such as video watching and live-video teaching, thus facilitating the study of students. In addition, the writing pen can be attracted to the side face of the tablet computer body and can be stored more conveniently without additionally disposing a protective cover around the tablet computer body. The heat-dissipation region is reserved on the back side provided with the ink screen assembly, so that the ratio of the area of an ink screen to the area of the tablet computer is decreased, the tablet computer has a sufficient heat-dissipation space, and the defect of poor heat-dissipation caused by two screens is overcome. In the invention, the size of the display region of the ink screen assembly is only 5.65 inches, the size of the display region of the liquid crystal screen is only 6.98 inches, and the PCBA of the double-screen tablet computer is located above the battery, so that the internal structure is compact, and the layout is reasonable; and the overall thickness of the tablet computer is only 9.7 mm, and the sizes and thickness allow the tablet computer to be handheld by students more easily for use.

The above description is merely for explaining the embodiments of the invention, and is not intended to limit the patent scope of the invention. All equivalent transformations obtained according to the contents of the specification and drawings of the invention, or direct or indirect applications to relating technical fields should also fall within the protection scope of the invention.

1. A double-screen tablet computer for students, comprising a tablet computer body, a liquid crystal screen assembly and an ink screen assembly, wherein:
the liquid crystal screen assembly and the ink screen assembly are disposed on a front side and a back side of the tablet computer body respectively and are electrically connected to the tablet computer body;
the back side provided with the ink screen assembly has a heat-dissipation region.

2. The double-screen tablet computer for students according to claim 1, wherein the tablet computer body comprises a holder, a frame and a PCBA;
the holder is disposed in the frame;
the PCBA is disposed on a side, facing the liquid crystal screen assembly, of the holder;
the liquid crystal screen assembly and the ink screen assembly are respectively disposed at openings in two sides of the frame.

3. The double-screen tablet computer for students according to claim 2, wherein the frame is made of aluminum alloy.

4. The double-screen tablet computer for students according to claim 2, wherein the holder is connected to the frame in a buckled manner through buckles.

5. The double-screen tablet computer for students according to claim 1, wherein the double-screen tablet computer for students has a thickness of 9.5 mm-9.7 mm.

6. The double-screen tablet computer for students according to claim 1, further comprising a camera, wherein:
the camera is disposed on a side, backing onto the liquid crystal screen assembly, of the tablet computer body and is covered with the ink screen assembly;
the camera is electrically connected to the tablet computer body.

7. The double-screen tablet computer for students according to claim 6, wherein the camera is detachably connected to the tablet computer body through buckles.

8. The double-screen tablet computer for students according to claim 1, wherein a mounting groove is formed in a side face of the tablet computer body;
an attraction member for attracting a writing pen is disposed in the mounting groove.

9. The double-screen tablet computer for students according to claim 1, wherein a display region of the liquid crystal screen assembly has a size of 6.98 inches.

10. (canceled)

11. The double-screen tablet computer for students according to claim 2, wherein a display region of the liquid crystal screen assembly has a size of 6.98 inches.

12. The double-screen tablet computer for students according to claim 3, wherein a display region of the liquid crystal screen assembly has a size of 6.98 inches.

13. The double-screen tablet computer for students according to claim 4, wherein a display region of the liquid crystal screen assembly has a size of 6.98 inches.

14. The double-screen tablet computer for students according to claim 5, wherein a display region of the liquid crystal screen assembly has a size of 6.98 inches.

15. The double-screen tablet computer for students according to claim 1, wherein a display region of the ink screen assembly has a size of 5.65 inches.

16. The double-screen tablet computer for students according to claim 2, wherein a display region of the ink screen assembly has a size of 5.65 inches.

17. The double-screen tablet computer for students according to claim 3, wherein a display region of the ink screen assembly has a size of 5.65 inches.

18. The double-screen tablet computer for students according to claim 4, wherein a display region of the ink screen assembly has a size of 5.65 inches.

19. The double-screen tablet computer for students according to claim 5, wherein a display region of the ink screen assembly has a size of 5.65 inches.
